(19) United States
(12) Patent Application Publication
(10) Pub. No.: US 2026/0299799 A1
(43) Pub. Date: Oct. 1, 2026

(54) Method, Operating System Dataset and Secure Element with a Commit Buffer including Memory Address Space for Suspended State Backups, as well as User Device comprising same

(71) Applicant: Giesecke+Devrient Mobile Security Germany GmbH, Munich (DE)

(72) Inventors: Luis Miguel Amoros, El Prat de Llobregat (Barcelona) (ES); Sanz Bernat, El Prat de Llobregat (Barcelona) (ES); Jawale Vaibhav, New Delhi (IN); David Patiño, Barcelona (ES)

(73) Assignee: Giesecke+Devrient Mobile Security Germany GmbH, Munich (DE)

(21) Appl. No.: 19/576,175

(22) Filed: Mar. 24, 2026

(30) Foreign Application Priority Data
Mar. 26, 2025 (DE) 102025111731.4

(51) Int. Cl. G06F 3/06

(52) U.S. Cl. CPC G06F 3/062; G06F 3/0619; G06F 3/0659; G06F 3/0679

(57) ABSTRACT

A method, an operating system dataset, a secure element and a user device with such a secure element are provided for configuring the user device, in particular for secure operation involving a trusted entity. The method includes providing a secure element of the user device, having a secure storage location configured to store at least one user profile dataset for a user adapted to operate the secure element and to enable access a secured service, such as at least one mobile telecommunication network; and assigning a commit buffer to at least one memory region of the secure storage location for storing metadata required for memory management and supporting data transactions; wherein the commit buffer is included in memory address space of the at least one memory region dedicated to store suspended state backups of data relating to the at least one user profile dataset in a suspended state.

### CROSS REFERENCE TO RELATED APPLICATIONS

This application claims priority to DE Application No. 102025111731.4 filed Mar. 26, 2025, which is hereby incorporated in its entirety by reference.

### TECHNICAL FIELD

The present disclosure relates to the field of configuring user devices, for example, smart cards, transaction cards, personal mobile devices or Internet-of-Things (IoT) devices, or alike, for being securely operated by an authorized user, for instance for conducting secure transactions and/or participating in communication networks.

### BACKGROUND

User devices, such as smart cards (e.g., so-called java cards), identification cards, transaction cards, personal mobile devices or IoT-devices, are known from the prior art. The user devices are commonly configured to employ electronic subscriber profiles authenticating a user for secure transactions or communicating on telecommunication networks, e.g., mobile networks. Such user devices are typically equipped with an electronic/embedded secure element (SE, eSE), also known as tamper resistant element (TRE), which may take the form of an UICC, eUICC, iUICC, SIM, eSIM, iSIM, or alike, configured to store one or more of the electronic user and/or subscriber profiles that may allow the user devices to access secured services, such as to connect to one or more mobile networks. A subscriber profile (e.g., an eSIM profile) may be generated by a mobile network operator (MNO) and may be stored, e.g., downloaded to a mobile user device. The subscriber profile may then be installed on a secure element of the user device and used for communication over a corresponding mobile network by the user device.

Secure elements are run by operation systems (OS) containing software and/or firmware for operating the secure elements, including the user profile datasets and any application program datasets, such as applets, which can be provided in connection thereto. Those OS need to be up to date in order to provide full and reliable functionality of the secure elements. An OS Update is especially relevant with the deployment of embedded Secure Elements (eSE) in the form of eUICC or alike.

The subscriber profiles are commonly provided as user profile datasets based on diversified data relating to a respective user. For accessing secured services, such as data accesses, access to data objects, and/or mobile telecommunication networks, the user profile datasets comprise respective security credentials. The application program datasets can be installed on the secure elements to perform certain operations in relation to and/or making use of the user profile datasets. If several profiles and/or application program datasets are present in the secure element, for example, the memory space available in the secure element might not be sufficient and has to be managed accordingly.

DE 101 41 926 A1, for example, refers to a method for managing a data memory having memory pages each having a plurality of memory words, wherein access to the entire memory page is required to write a memory word. The method supports transactions with atomic write operations, wherein memory images are stored in a return buffer to allow the memory contents to be returned with regard to the atomic write operations of the transaction if the transaction is aborted. Furthermore, the method supports non-atomic write operations during ongoing transactions. At least when a memory image of a memory page affected by the non-atomic write operation is present in the return buffer, a memory image modified in accordance with the non-atomic write operation is created on the basis of the existing memory image, so that when the memory content is returned, the effects of successfully completed non-atomic write operations on the memory content are retained. A microcontroller and a chip card have corresponding features. The disclosure provides a memory management system for a data storage device that can only be written to page by page, which supports both atomic and non-atomic write operations in transactions.

EP 2 711 871 A2 describes an IC card including a communication unit, a storage unit that stores a file, and a controller that interprets and executes a command instruction. The controller judges, when a command that instructs to select a dedicated file is input from an external apparatus, whether a certain fixed value is inserted at a predetermined position of the command, starts, when judged that the certain fixed value is inserted in a non-transaction state, transaction processing after accepting the command as a transaction start instruction simultaneous with the selection of the dedicated file, accepts, when judged that the certain fixed value is inserted during the transaction processing, the command as a commit instruction, and collectively reflects an operation performed during the transaction processing on all files managed under the dedicated file as a target.

Methods for configuring user devices with secure elements with memory management as known from the prior art may not deliver fully satisfying results, in particular when trying to solve certain resource and memory constraints of secure elements. Especially when a large number of applications should be implemented, available virtual memory might not be sufficient. Normally, a virtual memory region is used for suspended states backups, however, it has to be considered, that no hot-spot should be created in respective memory regions which are usually configured as non-volatile memory (NVM). Hot spots might occur because the same pages are used for suspended states backup over and over again, even if the available memory space is managed in a circular manner.

This may limit the functionality, especially a spectrum of (future) capabilities, of the user device, may compromise functional safety and security when operating user devices, or may even lead to that the devices cannot be configured properly, keeping in mind that not only the OS but also related data structures can be affected by updating procedures. Furthermore, interoperability and/or compatibility issues may arise when different entities provide and/or manage user profile datasets on the one hand, as well as operating datasets on the other hand. This can become particularly problematic in view of the limited memory space of secure storage locations of secure elements and a potentially limited amount of memory accesses, i.e., memory lifetime, which may be particularly impaired if memory hotspots are created, where locally significantly higher numbers of memory accesses take place in the secure element.

### SUMMARY

It may be seen as an object to improve the management of memory space available in secure elements. In particular, it may be seen as an object to provide a way to handle secure elements and their OS such that a future proof functional spectrum, safety and security may be assured, while not compromising deployability, availability, and/or data integrity, especially with regard to the limited memory space provided in secure elements. These objects are at least partly achieved by the subject-matter of the independent claims.

In particular, the present disclosure relates to a method of configuring a user device, in particular for secure operation involving a trusted entity, to an operating system dataset for operating a secure element of a user device, such as an eUICC, to a secure element, such as an eUICC, for a user device, and to a user device, such as a mobile device or an IoT device, configured for secure operation involving a trusted entity.

According to an aspect, a method of configuring a user device, in particular for secure operation involving a trusted entity, is provided, the method comprising the steps of providing a secure element, such as an eUICC, of the user device, having a secure storage location configured to store at least one user profile dataset for a user adapted to operate the secure element and to enable access a secured service, such as at least one mobile telecommunication network; and assigning a commit buffer to at least one memory region of the secure storage location for storing metadata required for memory management and supporting data transactions; wherein the commit buffer is included in memory address space of the at least one memory region dedicated to store suspended state backups of data relating to the at least one user profile dataset in a suspended state.

According to an aspect, an operating system dataset for operating a secure element of a user device, such as an eUICC, is provided, wherein the operating system dataset is configured to carry out a corresponding method.

According to an aspect, a secure element, such as an eUICC, for a user device, having a secure storage location configured to store at least one user profile dataset for a user adapted to operate the secure element and to enable access a secured service, such as at least one mobile telecommunication network for a user device, wherein the secure element is configured to carry out a corresponding method and/or has stored thereon a corresponding operating system dataset.

According to an aspect, a user device is provided, such as a mobile device or an IoT device, in particular to be configured for secure operation involving a trusted entity, configured for secure operation involving a trusted entity, wherein the user device comprises a corresponding secure element.

A configuration program for configuring a user device, in particular for secure operation involving a trusted entity, can be provided, wherein the configuration program comprises instructions which, when the configuration program is executed by a server device, a user device, and/or a secure element, cause the server device, the user device, and/or the secure element to carry out a corresponding method. An application program dataset in the form of a memory management unit (MMU) for operating a secure element of a user device, such as an eUICC, can provided, for example, as a part of the operating system dataset, wherein the application program dataset is configured to carry out a corresponding method and/or configured with a corresponding configuration program. A computer-readable data carrier may be provided having stored thereon a corresponding configuration program, a corresponding operating system dataset and/or a corresponding application program dataset. A server device, such as a security server providing a secure location for handling user profiles, can be provided, in particular for secure operation of user devices involving a trusted entity, wherein the server device is configured to carry out a corresponding method, comprises a corresponding configuration program, a corresponding operating system dataset, a corresponding application program dataset, and/or a corresponding computer-readable data carrier.

The proposed solution allows to commit relatively large buffers, since the dedicated memory region is used for a committed purpose and includes the memory address space used for the suspended state backups. Thereby, free commit buffer pages can be used as suspended use backup pages, whereas according to the prior art the backups are being stored in virtual memory regions. In other words, the backups can now be assigned to the commit buffer. New memory pages can be generated in commit buffer regions.

The solution has the advantage over the prior art that additional memory space is being made for cyclic memory accesses, thus reducing a likelihood of building hot spots. This improves the management of memory space available in secure elements. Secure elements and their OS can be handled such that a future proof functional spectrum, safety and security may be assured, while not compromising deployability, availability, and/or data integrity, especially with regard to the limited memory space provided in secure elements.

The secure element may be understood as a tamper resistant element (TRE). The application program dataset may comprise and/or involve program application and/or application programming interface (API). A complete operating system update dataset comprising at least one update data subset may be provided for replacing the previously installed operating system dataset. User profile datasets can be regarded as being managed on top of the respective OS.

The application program dataset may at least in part be provided on the secure element and can be configured to interact with the user device and/or at least one network terminal thereof. In other words, the application program dataset may at least partly run on the secure element, for example, as a part of an operating system dataset configured to operate the secure element. Additionally, an installation program dataset can be provided for installing and/or managing the application program dataset, such as for installing and/or updating an operating system dataset or respective update data subsets, including the application program dataset. Both, application program dataset and the installation program dataset may be integrated as data subsets into a customization dataset, such as a firmware suite allowing for customization of data on the secure element as described herein.

The application program dataset may be provided as a part of an operating system dataset of the secure element and/or may be configured to interact with the operating system dataset. A complete operating system dataset and/or subsets thereof may comprise the application program dataset. The operating system dataset and/or application program dataset may be configured to read, write, delete, manage and/or administer any kind of data object stored on the secure element and such are the user device. Data objects can be and/or comprise any kind of data element or constructs of data, including, but not limited to data gateways, data accesses, data streams, data blocks, data files, or alike, such as binaries, sounds, images, videos, text, emails, documents, images, folders, etc. The expression “dataset” can be understood as any kind of data composition, such as a file, including source code, object code, or binaries, which may have or fulfil a certain technical function.

Further developments can be derived from the dependent claims and from the following description. Features described with reference to a user device, secure element, server device and components thereof may be implemented as method steps, or vice versa. Therefore, the description provided in the context of the user device, secure element, server device and their components apply in an analogous manner also to respective methods. In particular, features and functions of the user device, secure element, server device and their components may be implemented as method steps which in turn may be implemented as respective device features or functions.

According to a possible embodiment, the commit buffer contains spare pages of the at least one memory address space. The spare pages can be part of a physical memory. This helps in managing and limiting memory use in order to enhance or at least maintain overall performance and future proof functional spectrum.

According to a possible embodiment, the spare pages are adapted to be used to store a memory map mapping a virtual storage to a physical memory of the at least one memory region. The usage of available physical memory can thereby be optimized. This further helps in managing and limiting memory use in order to enhance or at least maintain overall performance and future proof functional spectrum.

According to a possible embodiment, metadata pages extract mapping pages and all corresponding physical pages which are storing data corresponding to virtual memory. The meta data pages allow to enhance the mapping operations. This additionally helps in managing and limiting memory use in order to enhance or at least maintain overall performance and future proof functional spectrum.

According to a possible embodiment, identified free memory pages of the at least one memory region are being used for storing suspended state backups. The memory space provided by the identifying free memory pages and using them for storing suspended state backups additionally helps in making memory space available for cyclic memory accesses, thus reducing a likelihood of building hot spots. This further improves the management of memory space available in secure elements.

According to a possible embodiment, the suspended state backups are being read from in an exact order in which they have been stored. The suspended state backups can be read from the identified memory free pages. This helps in organizing and limiting memory space operations necessary to perform operations in relation to suspended state backups.

According to a possible embodiment, the method further comprises the step of applying a wear levelling scheme to the at least one memory region. The wear levelling scheme can evenly distribute memory operations within the at least one memory region thus reducing a likelihood of building hot spots. This additionally improves the management of memory space available in secure elements.

### BRIEF DESCRIPTION OF THE DRAWINGS

FIG. 1 is a schematic illustration of an exemplary embodiment of a configuration system configured for carrying out a method according to the present disclosure.

FIG. 2 shows a schematic illustration of an exemplary memory usage scheme involving the use of a commit buffer for suspended state backups.

### DETAILED DESCRIPTION OF EMBODIMENTS

The following detailed description is merely exemplary in nature and is not intended to limit the disclosure and uses of the disclosure. Furthermore, there is no intention to be bound by any theory presented in the preceding background or the following detailed description. The representations and illustrations in the drawings are schematic and not to scale. Like numerals denote like elements. A greater understanding of the described subject matter may be obtained through a review of the illustrations together with a review of the detailed description that follows.

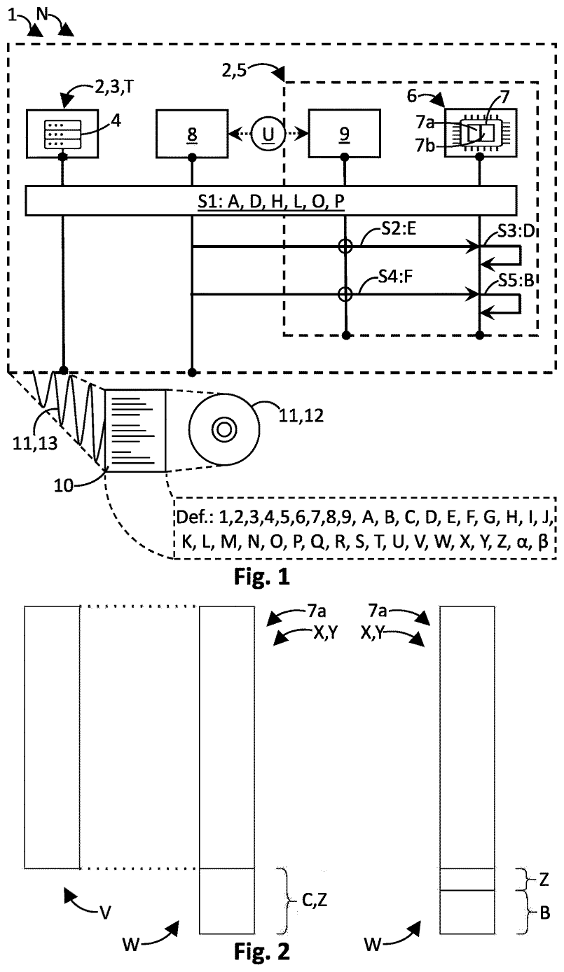

FIG. 1 shows a schematic illustration of a configuration system 1 comprising a computing device 2, for instance, in the form of a server device 3 controlled by a trusted entity T, which can include a hardware security module 4 adapted to store, manage and/or provide, application program datasets A operating system datasets O, and/or user profile datasets P for configuring a further computing device 2, for example, in the form of a user device 5 which may be embodied as an Internet of Things (IoT) device, such as a multimedia device, camera, speaker, household appliance, measurement device, industrial installation, vehicle, vending machine, or alike, to be associated with a machine entity, and/or as a smart card, an identification card, a transaction card, a personal mobile device, such as a smartphone, smartwatch, etc., to be associated with a personal entity. For example, the server device 3 may be provided in the form of a Server for Subscription Manager Data Preparation+(SM−DP+).

In the present example, the user devices 5 may be adapted for secure operation, transactions and/or communication, e.g., via a telecommunication network N by means of at least one user profile dataset P to be saved in a respective secure element 6 or tamper resistant element (TRE), such as an UICC, eUICC, iUICC, SIM, eSIM, iSIM, SE, eSE, or alike, provided in the form of a computer chip. The user profile data sets P are generated based on respective personal records contained in data files on the server device 3, in particular, the hardware security module 4 thereof. For storing and managing user profile data sets P on the secure elements 6, an operating system dataset O is installed on the secure element 6, for example, in a secure storage location 7, such as an Issuer Security Domain-Root (ISD-R) provided on the secure element 6. The secure storage location may provide different memory regions, such as at least one first memory region 7a and at least one second memory region 7b. The operating system dataset O comprises an executable data subsets which can be provided in the form of an application program dataset A of an application process, for example, in the form of and/or comprising a memory management unit (MMU) configured to access and manage the memory regions 7a, 7b and any data objects D stored therein.

A management application 8 may be provided which can be configured to allow a user U to communicate with the user device 5, in particular the secure element 6, for example, directly and/or through a communication interface 9 to the user device 5. The management application 8 can be provided in the form of a remote manager, such as an eSIM IoT remote manager (eIM) which may be securely identified by means of an application identifier and/or authenticated by means of an authentication certificate. The communication interface 9 may be provided in the form of a logical end-to-end interface (ESep) enabling secure communications between the management application 8 and the secure element 6, which can be used to transfer data packages, such as eUICC Packages, for instance to carry out Profile State Management and eIM configuration tasks by means of the eIM. For example, the communication interface 9 may be provided as a part of a local management application, such as a IoT Profile Assistant (IPA), which may take the form of an IoT Profile Assistant (IPAd) provided to the user device 5, and/or an IoT Profile Assistant provided (IPAe) arranged in the secure element 6. Alternatively, or additionally, the management application 8 and/or communication interface 9 may be provided as a local profile assistant (LPA) provided to the user device 5 and/or arranged in the secure element 6

Furthermore, the operating system dataset O may comprise or be combined with at least one user profile P and/or security credentials H, including application identifiers, authentication certificates and/or security keys. The security credentials H may comprise any kind of credentials defined by e.g., the GSMA, or alike. The security keys may comprise any kind of cryptographic code or key element which may be adapted to interact with the user devices 5, the secure elements 6, and/or the server device 3 of the trusted entity T as an issuer of any part of the operating system dataset O and/or any component thereof. The authentication certificates may be any kind of electronic certificate, for example, that can be issued by the trusted entity T, for authenticating an origin of the user devices 5, the secure elements 6, the secure storage location 7, the application program dataset A and/or the operating system dataset O. Transmission lines (not shown) may be provided for handling and/or transferring the operating system dataset O may comprise any kind of wired and/or wireless transmission chains, including the Internet (for transmissions “Over-The-Air”) as well as other physical and/or non-physical data carriers, which can be configured and secured as desired and required by the configuration system 1 and its components.

In any of the embodiments of the configuration system 1 as described herein, in particular the computing devices 2, can be configured to execute a computer program in the form of a configuration program 10. A computer-readable data carrier 11 can have stored thereon the configuration program 10 and may take the form of a computer-readable medium 12 and/or data carrier signal 13. When carrying out the configuration program 10, the configuration system 1 and any components thereof communicate as specified in the configuration program 10. Parameters associated with and/or underlying the configuration system 1, any of the components thereof and/or any steps S carried out thereby, can at least in part be defined in and/or by the configuration program 10.

In a first step S1, the server device 3 may provide any of the data components of the configuration system 1, including the operating system dataset O, possibly along with the application program dataset A, data objects D, security credentials H, installation program datasets, respective diversified data L, and/or at least one user profile dataset P associated with the user U, to the secure element 6 of the user device 5, for example through the communication interface 9 to be stored in the secure storage location 7 for deployment to the user U. Any data objects D, in particular the user profile dataset P, may be stored in the designated memory region 7a, 7b, the respective data object D and/or user profile dataset P is supposed to occupy and/or to use. The data objects D and the at least one user profile dataset P may be further provided with memory requirements R indicating an amount of memory they might occupy and/or use, as well as possibly any usage characteristics, such as a certain frequency of data access or alike.

In a second step S2, the user U may activate or enable the at least one profile dataset P to operate the user device 5 with the secure element 6 accordingly. The at least one user profile dataset P is thereby set into an enabled state E which may involve loading certain data objects D from the designated memory region 7a, 7b. In a fourths step, the user U may deactivate or disable the at least one profile dataset P, for example, by shutting down the user device 5. The at least one user profile dataset P is thereby set into a disabled state F which may involve storing a respective suspended state backup B including certain data objects D in the designated memory region 7a, 7b.

FIG. 2 shows a schematic illustration of an exemplary memory usage scheme involving the use of a commit buffer C for suspended state backups B to be stored, for example, if the at least one user profile dataset P is being put in the disabled state F. In the present example, the memory region 7a is being used and may be assigned to a virtual memory V. The memory region 7a provides a corresponding physical memory W with memory addresses X providing a respective memory space Y which should match the size of the virtual memory V, and should further provide enough memory space Y for offering the commit buffer C and administrative pages Z. The commit buffer C is included in the memory address space Y of the memory region 7a dedicated to store suspended state backups B of data, such as certain data objects D, relating to the at least one user profile dataset P in the disabled state F, which can be any suspended or deactivated or disabled state F or alike, where the user profile dataset P is currently not in use. Memory pages Z used for storing the suspended state backups B do not need to be continuous but can be used as they are free.

According to the present exemplary embodiments, suspend and resume operations used to implement shutdown or hibernate functionalities of user profile datasets P can make use of the commit buffer C for storing suspended state backups B, for example, when the communication interface 9, such as a communication terminal of the user sends the command of suspend or disable a user profile dataset P to the secure element 6. After receiving the suspend command, and fulfilling pre-requisites to execute the suspend command, the operating system dataset, in particular the application program dataset A providing memory management, shall save the suspended state backup B, which may include all relevant states, variables, context, etc., to the designated memory region 7a, 7b, such as a NVM, so that after receiving a resume command, a previous state of respective data objects D can be recovered.

NVM typically refers to storage in semiconductor memory chips, which store data in floating-gate memory cells consisting of floating-gate MOSFETs (metal-oxide-semiconductor field-effect transistors), including flash memory storage such as NAND flash and solid-state drives (SSD). For example, ETSI 102 221 specifies commands to implement such commands. After receiving the commands, an internal status of the secure element 6, such as an UICC, can be stored to the NVM, so that a power supply of the UICC can be switched off and the UICC can be restored after receiving the resume command.

The application program dataset A, for example, in the form of a MMU, can be based on virtual address space. A relatively large commit buffer can be required to store metadata and support transactions. The commit buffer C is commonly used to store updated data during transactions. In this context, the application program dataset can provide atomicity via a transaction management system and thus provides endurance. The commit buffer C can be used as backup buffer during transaction for roll-back. Every virtual page can be written to a new free page in the commit buffer C which while doing so and/or after a transaction can be regarded as being committed. Current free pages can be part of the commit buffer C for a next transaction. Hence, a storage area of the commit buffer C is refreshing during each transaction. The refreshing makes the commit buffer C very useful for overlaying with mutually exclusive high endurance requirement applications like power saving suspend functionalities, or alike.

According to the presented exemplary embodiments, spare pages in the physical memory W can be used to store the virtual to physical mapping, while free memory pages Z in the commit buffer C can be used to store the suspended state backup B, for instance, in the form of SUSPEND UICC backup pages. Memory pages Z containing meta data can extract mapping pages and all corresponding physical pages which are storing data corresponding to virtual memory V. All identified free memory pages Z can be used to backup the UICC state. Upon reactivation of the user profile dataset P, the backup can be read from all identified free memory pages Z in the exact order in which they have been stored.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It will be understood that various changes may be made in the function and arrangement of elements described in an exemplary embodiment without departing from the scope of the claims.

Additionally, it is noted that “comprising” or “including” does not exclude any other elements or steps and “a” or “an” does not exclude a multitude or plurality. It is further noted that features or steps which are described with reference to one of the above exemplary embodiments may also be used in combination with other features or steps of other exemplary embodiments described above. Reference signs in the claims are not to be construed as a limitation.

1. A method of configuring a user device for secure operation involving a trusted entity, the method comprising the steps of
providing a secure element of the user device, having a secure storage location configured to store at least one user profile dataset for a user adapted to operate the secure element and to enable access to a secured service; and
assigning a commit buffer to at least one memory region of the secure storage location for storing metadata required for memory management and supporting data transactions;
wherein the commit buffer is included in memory address space of the at least one memory region dedicated to store suspended state backups of data relating to the at least one user profile dataset in a suspended state.

2. The method according to claim 1, wherein the commit buffer contains spare memory pages of the at least one memory address space.

3. The method according to claim 2, wherein the spare memory pages are adapted to be used to store a memory map mapping a virtual memory to a physical memory of the at least one memory region.

4. The method according to claim 2, wherein metadata pages extract mapping pages and all corresponding physical pages which are storing data corresponding to virtual memory.

5. The method according to claim 1, wherein identified free memory pages of the at least one memory region are being used for storing suspended state backups.

6. The method according to claim 1, wherein the suspended state backups are being read from in an exact order in which they have been stored.

7. The method according to claim 1, further comprising the step of applying a wear levelling scheme to the at least one memory region.

8. The method according to claim 1, wherein the secure element includes an eUICC.

9. The method according to claim 1, wherein the secured service comprises at least one mobile telecommunication network.

10. A non-transitory computer readable medium, comprising:
an operating system dataset for operating a secure element of a user device, wherein the operating system dataset is configured to carry out, via a processor, a method comprising:
providing a secure element of the user device, having a secure storage location configured to store at least one user profile dataset for a user adapted to operate the secure element and to enable access a secured service, such as at least one mobile telecommunication network; and
assigning a commit buffer to at least one memory region of the secure storage location for storing metadata required for memory management and supporting data transactions;
wherein the commit buffer is included in memory address space of the at least one memory region dedicated to store suspended state backups of data relating to the at least one user profile dataset in a suspended state.

11. The non-transitory computer readable medium according to claim 10, wherein the commit buffer contains spare memory pages of the at least one memory address space.

12. The non-transitory computer readable medium according to claim 11, wherein the spare memory pages are adapted to be used to store a memory map mapping a virtual memory to a physical memory of the at least one memory region.

13. The non-transitory computer readable medium according to claim 11, wherein metadata pages extract mapping pages and all corresponding physical pages which are storing data corresponding to virtual memory.

14. The non-transitory computer readable medium according to claim 10, wherein identified free memory pages of the at least one memory region are being used for storing suspended state backups.

15. The non-transitory computer readable medium according to claim 10, wherein the suspended state backups are being read from in an exact order in which they have been stored.

16. The non-transitory computer readable medium according to claim 10, wherein the method further comprises the step of applying a wear levelling scheme to the at least one memory region.

17. The non-transitory computer readable medium of claim 10, wherein the secure element comprises an eUICC.

18. A user device, comprising:
a secure element having a secure storage location configured to store at least one user profile dataset for a user adapted to operate the secure element and to enable access a secured service; and
assigning a commit buffer to at least one memory region of the secure storage location for storing metadata required for memory management and supporting data transactions;
wherein the commit buffer is included in memory address space of the at least one memory region dedicated to store suspended state backups of data relating to the at least one user profile dataset in a suspended state.

19. The user device of claim 18, where in the secure element comprises an eUICC.

20. The user device of claim 19, wherein the user device comprises at least one of a mobile device and an IoT device.
